(19) United States
(12) Patent Application Publication
(10) Pub. No.: US 2004/0221820 A1
(43) Pub. Date: Nov. 11, 2004

(54) Variable engine cycle engine

(76) Inventors: Cornelius N. Opris, Peoria, IL (US); Scott B. Fiveland, Peoria, IL (US); Jonathan P. Kilkenny, Peoria, IL (US)

Correspondence Address: Todd T. Taylor, Taylor & Aust, P.C., 142 S. Main Street, P.O. Box 560, Avilla, IN, 46710, US

(21) Appl. No.: 10/430,738

(22) Filed: May 6, 2003

(51) Int. Cl. F02B 69/06

(52) U.S. Cl. 123/21

(57) ABSTRACT

An engine particularly suited to powering work machines operated under varying loads. The engine includes a plurality of combustion cylinders operable in a homogenous charge compression ignition mode, each adapted to operate in both two-stroke and four-stroke cycles. Variable compression ratios and boost are available to improve performance.

### TECHNICAL FIELD

The present invention relates generally to the field of internal combustion engines, and more specifically to engines operated under homogenous charge compression ignition principles.

### BACKGROUND

In a direct injection compression ignition engine, such as a diesel engine, it is common to use either a two-stroke or a four-stroke operating sequence. Each has certain advantages and disadvantages.

On the downward stroke of a piston in a combustion cylinder of a two-stroke engine, ports for air intake are opened and a charge of air is received in the combustion cylinder. Turbochargers are often used to supply the charge air at higher pressure and density than existing ambient conditions. On the upward stroke of the cylinder, the air intake ports are closed and the air is highly compressed. At the desired point of compression, fuel is sprayed into the cylinder by a fuel injector. The fuel ignites immediately, as a result of the heat and pressure inside the cylinder. The pressure created by the combustion of the fuel drives the piston downward in the power stroke of the engine. As the piston nears the bottom of its stroke, all of the exhaust valves open. Exhaust gases rush from the cylinder, relieving pressure in the cylinder. The intake ports are opened, and pressurized air fills the cylinder, forcing out the remaining exhaust gases. The exhaust valves close and the piston starts traveling back upward, the intake ports are closed and the fresh charge of air is compressed in the cylinder, in preparation for fuel injection.

In a four-stroke engine, the various functions are separated into individual cycles of the piston. Combustion forces the piston downward in a power stroke, the following upward stroke of the piston is associated with expelling combustion gases in an exhaust stroke. The next downward stroke is an intake stroke for combustion air, followed by an upward compression stroke.

Thus, in a two-stroke engine, each downward cycle of the piston is a power stroke, immediately following initiation of combustion. In a four-stroke engine, only every second downward stroke is a power stroke following combustion.

Engine emission standards have led to the investigation of engine operating and ignition alternatives. In one such alternative, referred to as homogenous charge compression ignition (HCCI), significant emission reductions have been experienced during initial testing. In an engine operating under HCCI concepts, the air and fuel are intimately mixed, typically at a high air/fuel ratio, before maximum compression in the combustion cylinder. This can be achieved, for example, by the use of a fuel system having an injector able to vary the angle of injection as the piston moves from a bottom dead center position to a top dead center position. By way of further example, this also can be achieved by the use of an injector injecting a homogenous mixture of fuel and air into the combustion cylinder.

As used herein, including the claims to follow, operation under HCCI concepts should be understood to encompass features and concepts whereby air and fuel are intimately mixed before maximum compression, and each droplet of fuel is surrounded by combustion air in excess of the amount required for combustion. In a compression ignition engine, as compression occurs, the air temperature increases, and ultimately combustion is initiated at numerous locations throughout the cylinder. Typically, combustion commences at lower temperatures than for direct charge ignition, leading to reduced NOₓ emissions.

The use of homogenous charge compression ignition results in reduced NOₓ and particulate matter emissions. However, while homogenous charge compression ignition combustion presents advantages from emissions and fuel consumption view points, it presents challenges in control strategies, especially for engines operated under a wide range of load conditions. Four-stroke engines using homogenous charge compression ignition concepts typically exhibit good operating patterns under light to part load conditions. However, for high power density at high load, two-stroke engine cycles are preferred. Two-stroke engine cycles provide additional benefits in higher levels of internal EGR control.

Multi-fuel, hybrid engines are known. U.S. Pat. No. 5,010,852 discloses an engine operable in both two-stroke and multi-stroke working cycles.

The present invention is directed to overcoming one or more of the problems as set forth above.

### SUMMARY OF THE INVENTION

In one aspect of the invention, an internal combustion engine is provided with a plurality of combustion cylinders operable under homogenous charge combustion concepts. Each cylinder has at least one intake valve, at least one exhaust valve and separate independent operators for each valve. Each combustion cylinder is adapted for operation alternatively in two-stroke and four-stroke cycles. A control unit connected to each operator selectively operates each valve alternatively in two-stroke and for stroke cycles.

In another aspect of the invention, a work machine is provided with a frame carrying an engine. The engine includes a block and a head defining a plurality of combustion cylinders operable under homogenous charge combustion concepts. Each cylinder has at least one intake valve, at least one exhaust valve and separate independent operators for each valve. Each combustion cylinder is adapted for operation alternatively in two-stroke and four-stroke cycles. A control unit is connected to each operator for selectively operating each valve alternatively in two stroke and four stroke cycles based on engine operating data.

In a further aspect of the invention, a method for operating an engine is provided, with steps of providing a plurality of combustion cylinders operable in a homogenous charge compression ignition mode; operating the plurality of combustion cylinders in a two-stroke cycle homogenous charge compression ignition mode under high load conditions; and operating the plurality of combustion cylinders in a four-stroke cycle homogenous charge compression ignition mode under low load conditions.

### BRIEF DESCRIPTION OF THE DRAWINGS

FIG. 1 is a sectional, partially fragmentary view of an embodiment of an internal combustion engine of the present invention within a work machine; and

FIG. 2 is a cross-sectional view taken along line 2-2 of FIG. 1.

### DETAILED DESCRIPTION

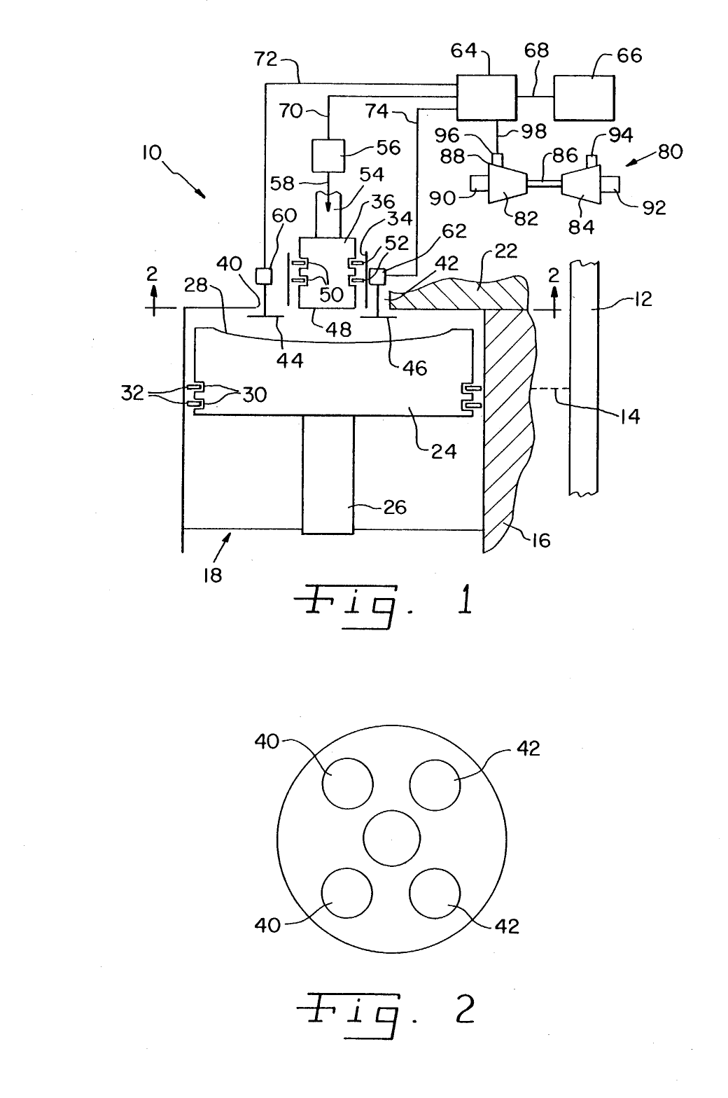

Referring now to the drawings, and more particularly to FIGS. 1 and 2, there is shown an embodiment of an internal combustion engine 10 of the present invention which is incorporated within a work machine such as an on-road vehicle, off-road vehicle, tractor, excavator or the like. Engine 10 also may be immobile, such as for a generating facility or the like, wherein the work machine is stationary. The work machine includes a frame 12 that carries internal combustion engine 10, as designated schematically by phantom line 14.

Engine 10 includes an engine block 16 that defines one or more combustion cylinders 18, and typically defines a plurality of combustion cylinders 18, which in preferred embodiments may be between one and twenty combustion cylinders. A head 22 is provided on block 16 above all cylinders 18. In accordance with the present invention, combustion cylinders 18 are designed and controlled to be operable under homogenous charge compression ignition (HCCI) concepts, in both two-stroke and four-stroke cycles. As stated previously herein, operation under HCCI concepts is achieved through the use of a fuel system that provides an intimate mixture of air and fuel, typically at a high air/fuel ratio, before maximum compression is reached.

While in most applications of the present invention a plurality of cylinders 18 are operable under HCCI concepts, for purposes of simplicity, only one such cylinder 18 operable under HCCI concepts is shown in the drawings. A primary piston 24 is reciprocally disposed within combustion cylinder 18, and movable between a top dead center position adjacent head 22 (as shown in FIG. 1) and a bottom dead center position at an opposing end of combustion cylinder 18. Primary piston 24 includes a rod 26 coupled therewith on a side opposite from head 22.

Primary piston 24 also includes a crown 28 having a predefined contour that assists in mixing the fuel and air mixture that is injected into combustion cylinder 18. The particular contour of crown 28 may vary, depending on the particular application. Fuel also can be provided premixed, as in a stationary natural gas engine. Primary piston 24 also includes one or more annular piston ring grooves 30 in the exterior periphery thereof, which each carry a respective piston ring 32. Piston rings 32 prevent blow-by of combustion products during a combustion cycle, as is known. Primary piston 24 may also be configured without piston ring grooves 30 and piston rings 32, depending upon the particular application.

Head 22 includes a secondary cylinder 34 that is in communication with HCCI combustion cylinder 18. A secondary piston 36 is reciprocally disposed in secondary cylinder 34. Head 22 also includes at least one intake port 40 and one exhaust port 42, and, as shown, includes a pair of intake ports 40 and exhaust ports 42 in which a corresponding pair of intake valves 44 and exhaust valves 46 are reciprocally disposed. In some uses of the present invention, head 22 can include more intake ports 40 than exhaust ports 42, or more exhaust ports 42 than intake ports 40, and is not limited to two but may include more than two intake ports 40 or exhaust ports 42. Intake ports 40 with intake valves 44 operatively disposed therein, and exhaust ports 42 with exhaust valves 46 operatively disposed therein, are optimized for good two-stroke scavenging as well as for four-stroke operation, having appropriate intake and exhaust porting and variable valve timing, as will be described more fully hereinafter.

Secondary cylinder 34 has a generally cylindrical shape in the embodiment shown, and preferably is positioned generally concentrically with combustion cylinder 18 and primary piston 24. However, it is also possible to position secondary cylinder 34 offset relative to a longitudinal axis of primary piston 24, depending upon the particular application. Secondary cylinder 34 is positioned adjacent to, and in communication with combustion cylinder 18, so as to affect the fluid dynamics and chemical kinetics of the fuel and air mixture during the combustion process in combustion cylinder 18.

Secondary piston 36 is reciprocally disposed within secondary cylinder 34, and movable between a top dead center position adjacent combustion cylinder 18 (as shown in FIG. 1) and a bottom dead center position at an opposite end of secondary cylinder 34. Secondary piston 36 includes a crown 48 with a predefined contour, depending upon the particular application. In the embodiment shown, crown 48 is generally flat, but may also have a curved surface or compound curvature, depending upon the particular application.

Secondary piston 36 includes a pair of piston ring grooves 50 that respectively carry a pair of piston rings 52. Piston rings 52 are configured to inhibit blow-by of combustion products during combustion of the fuel and air mixture within combustion cylinder 18. A rod 54 is coupled with secondary piston 36, and is directly or indirectly coupled with an actuator 56 as indicated by line 58. Secondary piston 36 is reciprocated within secondary cylinder 34 to affect the combustion timing of the fuel and air mixture within combustion cylinder 18, as primary piston 24 reciprocates within combustion cylinder 18.

Actuator 56 controls the reciprocating position of secondary piston 36, depending upon a position of primary piston 24 and operating conditions of engine 10. Actuator 56 is configured as a hydraulic actuator, and acts as a plunger shaft for reciprocating secondary piston 36 between the top dead center position and the bottom dead center position. When configured as a hydraulic actuator, it will be appreciated that secondary piston 36 may be moved to or through any desired location within secondary cylinder 34. Thus, the top dead center position and bottom dead center position of secondary piston 36 may vary. By varying the top dead center position of secondary piston 36, the effective compression ratio of primary piston 24 and combustion chamber 18 may likewise be varied.

In the embodiment shown, secondary piston 36 and secondary cylinder 34 each have a generally cylindrical shape (i.e., generally circular cross-sectional shape). However, depending upon the particular application, it is possible to configure secondary piston 36 and secondary cylinder 34 with a different cross-sectional shape, while still allowing effective reciprocation of the secondary piston within the secondary cylinder.

In accordance with the present invention, engine 10 is operable in both two-stroke and four-stroke cycles of each combustion cylinder 18. A variable valve timing system is used, without cam operation of intake valves 44 and exhaust valves 46. Thus, each intake valve 44 is connected to an intake valve operator 60, and each exhaust valve 46 is connected to an exhaust valve operator 62. Operators 60 and 62 are hydraulic actuators or the like, such that each intake valve 44 and each exhaust valve 46 is operable independently of the other intake valves 44 and exhaust valves 46, and independently of the movement and positions of primary piston 24 and secondary piston 36.

An engine control unit 64 is used to control and monitor various operations and functions of engine 10. Control unit 64 is capable of monitoring various functions of engine 10, by use of one or more sensors in a sensor system 66 associated with engine 10. Each sensor of sensor system 66 is connected to control unit 64 via a signal connection 68, which may be an electrically conductive wire. Sensors of sensor system 66 may be employed at various locations in engine 10, to sense various engine operating conditions, such as engine speed, intake manifold air temperature, intake manifold pressure, fueling rate, cylinder pressure, exhaust back-pressure, and various other load, boost and speed conditions, all of which are known to those skilled in the art. Sensor system 66 provides data signals with regard to the various conditions to control unit 64. Control unit 64 provides control signals to actuator 56, intake valve operators 60 and exhaust valve operators 62 via control operating connections 70, 72 and 74, respectively.

Engine 10 further includes a turbocharger 80, having a turbine 82 and a compressor 84 connected by a turbocharger shaft 86. Turbine 82 includes an inlet 88 and an outlet 90 connected in known manner to the exhaust system of engine 10. Turbine 82 is thereby powered by an exhaust gas stream from engine 10, and provides power to compressor 84 via shaft 86. Compressor 84 includes an inlet 92 for receiving combustion air, and an outlet 94 for supplying compressed combustion air to each combustion cylinder 18 of engine 10. Turbocharger 80 has a variable geometry turbine/compressor arrangement, schematically illustrated in FIG. 1 by variable inlet nozzle 96 on turbine 82. Those skilled in the art will recognize that variable inlet nozzle 96 is one example of a suitable arrangement to achieve variability in performance of turbocharger 80, in accordance with the present invention. Variability also can be achieved by the use of controllable nozzles on turbine 82 and/or compressor 84, other than variable inlet nozzle 96. Further, turbocharger 80 can be a multistage turbocharger, including a plurality of compressors 84. Control unit 64 is connected to turbocharger 80, via a control operating connection 98, to control the performance thereof, as necessary. A supercharger may also be used in addition to or in place of turbocharger 80.

### Industrial Applicability

During operation of engine 10, under light to part load conditions, cylinders 18 may be operated in a four-stroke cycle. Engine control unit 64 provides control signals to intake valve operators 60 and exhaust valve operators 62 to control opening and closing of intake ports 40 and exhaust ports 42 in the desired four-stroke operating mode. If control unit 64 determines from signal data received from sensor system 66 that operating in a two-stroke cycle would be advantageous, conversion from four-stroke cycles to two-stroke cycles occurs from one combustion cycle to the next. Engine control unit 64 provides control signals to intake valve operators 60 and exhaust valve operators 62 to control opening and closing of intake ports 40 and exhaust ports 42 in the desired two-stroke operating mode.

Secondary piston 36 can be positioned to establish the desired compression ratio, and intake and exhaust valve timing is controlled as desired, for both two-stroke and four-stroke cycles in that secondary piston 36, intake valves 44 and exhaust valves 46 all are independently controllable. Actuator 56, intake valve operator 60 and exhaust valve operator 62 are separately and individually operable, as desired. Advantages may be obtained if operation follows so-called Miller cycle principles, with late intake valve closing, as those skilled in the art will readily understand. Further, with the variable compression ratio available, Melchior cycles and other advantageous operating principles are readily available in the present invention.

During operation under HCCI concepts in either two-stroke or four-stroke cycles, primary piston 24 is reciprocated within combustion cylinder 18 between the bottom dead center position and the top dead center position as shown in FIG. 1, and vice versa. As primary piston 24 moves from the bottom dead center position to the top dead center position, intake valves 44 are actuated to draw in combustion air and/or an air and fuel mixture. A separate fuel injector (not shown) may also be provided. When primary piston 24 is at or near the top dead center position, and preferably shortly before the top dead center position, secondary piston 36 is likewise actuated and moved to the top dead center position adjacent combustion cylinder 18. This effectively causes a rapid decrease in the combined volumes of combustion cylinder 18 and its associated secondary cylinder 34, causing rapid compression of the air/fuel mixture. Sufficient energy is imparted to the fuel and air mixture within combustion cylinder 18 to cause the fuel and air mixture to combust. Secondary piston 36 is preferably held at the top dead center position for a predetermined period of time to maintain the total volume at a minimum.

After combustion, primary piston 24 is moved from the top dead center position toward the bottom dead center position. Secondary piston 36 is concurrently moved toward its bottom dead center position to effectively increase the total communicating volume area. In using hydraulic actuator 24, the bottom dead center position of secondary piston 36 may also be varied to in turn vary the compression ratio of internal combustion engine 10. The process repeats for each combustion cycle of primary piston 24 between the bottom dead center position and top dead center position, and vice versa.

As primary piston 24 moves toward the bottom dead center position, exhaust valves 46 are actuated to allow exhaust gas to exit from the combustion chamber within combustion cylinder 20.

By varying the timing of secondary piston 36, it is possible to likewise vary the timing of the combustion sequence occurring within combustion cylinder 18. Thus, it is possible to indirectly control the combustion sequence of the fuel and air mixture within combustion cylinder 18 using secondary piston 36. Alternatively, once a desired compression ratio has been determined and achieved, secondary piston 36 can be held at a fixed position to provide the desired compression ratio. Such steady state operation can continue for numerous combustion cycles.

Engine control unit 64 also provides control signals to turbocharger 80, such that variable geometry components thereof, such as variable inlet nozzle 96, are adjusted to obtain the desired performance of turbocharger 80. EGR volumes, back-pressure to boost ratio, inlet manifold temperature and other parameters are all controllable to establish both advantageous steady-state operating conditions and suitable transition operating conditions as operation is changed from two-stroke to four-stroke, or from four-stroke to two-stroke operation

Operation of engine 10 in accordance with the present invention is fuel independent, and any conventional fuel for internal combustion engines can be used.

In accordance with the present invention, it is possible to maximize the performance of engine 10 by selectively operating under two-stroke and four-stroke cycles. While relatively complex control strategies can be implemented through control unit 64, it can be understood generally that control unit 64 will control operators 60 and 62 to four-stroke operation mode during low load conditions, and to two-stroke operation mode during high load conditions. Control unit 64 can alter compression ratios and valve functions between two cycles, while also controlling secondary piston 36 to switch between low and high compression, as desired. With the related, and independent control of turbocharger 80, appropriate boost can be provided.

During the transition from four-stroke, to two-stroke operation, or vice versa, the valve events are retarded or advanced to phase combustion and ultimately change engine operating condition between two-stroke and four-stroke as needed. For example, in the transition from four-stroke to two-stroke, intake valves 44 are opened following the opening of exhaust valves 46 during cylinder 18 expansion. Exhaust valves 46 are closed during late expansion or early compression. The residual gas fraction may be higher than typical in four-stroke operation, since the exhaust valve event is truncated. To counteract this effect, the exhaust valve is closed later in the cycle than in the normal two-stroke operation. At the same time, depending on the boost to back-pressure ratio, a blower can be activated to increase cylinder scavenging. As two-stroke operation is phased in, intake valves 44 and exhaust valves 46 are closed earlier and earlier in compression, until the desired valve timing is reached. The rate of shifting the intake valve closing can be made to depend on the response of various sensed parameters (i.e. pressure, 50% burned fraction, speed, load, etc.) relative to the desired values.

The present invention combines two-stroke and four-stroke, with variable compression ratios and appropriate boost to provide improved controllability of the HCCI combustion mode for the specific conditions under which engine 10 is operating.

Other aspects, objects and advantages of this invention can be obtained from a study of the drawings, the disclosure and the appended claims.

What is claimed is:

1. An internal combustion engine comprising:
a plurality of combustion cylinders operable under homogenous charge combustion concepts, each said cylinder having at least one intake valve, at least one exhaust valve and separate independent operators for each valve;
each said combustion cylinder adapted for operation alternatively in two-stroke and four-stroke cycles;
a sensor system acquiring engine operating data; and
a control unit connected to each operator and to said sensor system for selectively operating each valve alternatively in two-stroke and for stroke cycles.

2. The engine of claim 1, said plurality of combustion cylinders adapted for variable compression.

3. The engine of claim 2, each said cylinder having at least two intake valves and at least two exhaust valves.

4. The engine of claim 2, including a variable performance turbocharger, and said control unit connected to said turbocharger to control the performance thereof.

5. The engine of claim 1, each said cylinder configured for compression ignition.

6. The engine of claim 1, including a variable performance turbocharger, and said control unit connected to said turbocharger to control the performance thereof.

7. The engine of claim 1, each said cylinder having at least two intake valves and at least two exhaust valves.

8. The engine of claim 1, said control unit adapted for operating said valves in accordance with Miller cycle principles.

9. The engine of claim 1, said control unit adapted for operating said valves in accordance with Melchior cycle principles.

10. A work machine comprising:
a frame carrying an engine;
said engine including a block and a head defining a plurality of combustion cylinders operable under homogenous charge combustion concepts, each said cylinder having at least one intake valve, at least one exhaust valve and separate independent operators for each valve;
each said combustion cylinder adapted for operation alternatively in two-stroke and four-stroke cycles;
a sensor system acquiring engine operating data; and
a control unit connected to receive the operating data, and connected to each operator for selectively operating each valve alternatively in two stroke and four stroke cycles based on the engine operating data.

11. The work machine of claim 10, said plurality of combustion cylinders adapted for variable compression.

12. The work machine of claim 11, each said cylinder having at least two intake valves and at least two exhaust valves.

13. The work machine of claim 11, including a variable performance turbocharger, and said control unit connected to said turbocharger to control the performance thereof.

14. The work machine of claim 13, said control unit adapted for operating said valves in accordance with Miller cycle principles.

15. The work machine of claim 14, said control unit adapted for operating said valves in accordance with Melchior cycle principles.

16. A method for operating an engine, comprising:
providing a plurality of combustion cylinders operable in a homogenous charge compression ignition mode;
operating said plurality of combustion cylinders in a two-stroke cycle homogenous charge compression ignition mode under high load conditions; and
operating said plurality of combustion cylinders in a four-stroke cycle homogenous charge compression ignition mode under low load conditions.

17. The method of claim 16, including operating using Melchior cycle principles.

18. The method of claim 16, including operating using Miller cycle principles.

19. The method of claim 16, including varying the compression ratio of said combustion cylinders during said operating in a two-stroke cycle homogenous charge compression ignition mode.

20. The method of claim 16, including varying the compression ratio of said combustion cylinders during said operating in a four-stroke cycle homogenous charge compression ignition mode.

21. The method of claim 16, including providing a variable geometry turbocharger, and varying the performance of said turbocharger.
